(19) United States
(12) Patent Application Publication
(10) Pub. No.: US 2026/0048725 A1
(43) Pub. Date: Feb. 19, 2026

(54) MODULATOR SYSTEM AND METHOD FOR OPERATING SAME

(71) Applicant: ZF CV Systems Global GmbH, Bern (CH)

(72) Inventors: Axel Stender, Hameln (DE); Jan-Christoph von der Beeke, Algermissen (DE); Norbert Witte, Lauenau (DE)

(21) Appl. No.: 19/367,729

(22) Filed: Oct. 23, 2025

Related U.S. Application Data
(63) Continuation of application No. PCT/EP2024/059701, filed on Apr. 10, 2024.

(30) Foreign Application Priority Data
May 3, 2023 (DE) 10 2023 111 486.7

(51) Int. Cl. B60T 8/88; B60T 7/20; B60T 8/17; B60T 8/32; B60T 8/94; B60T 13/26; B60T 13/68

(52) U.S. Cl. CPC B60T 8/885; B60T 8/1708; B60T 8/323; B60T 8/94; B60T 13/26; B60T 7/20; B60T 13/683; B60T 2240/00; B60T 2270/10; B60T 2270/30; B60T 2270/402; B60T 2270/413

(57) ABSTRACT

A modulator system for a brake system of a trailer vehicle includes a pneumatic brake installation which has a first modulator device. The first modulator device has a primary modulator and a first electronic control device. The primary modulator has an input for control pressure, an input for supply pressure, an output for brake pressure and an electrical input for electrical signals from the first electronic control device. The first electronic control device has an input for wheel speed signals and an output for connecting to the electrical input of the primary modulator. The primary modulator is able to be controlled by the first electronic control device. The modulator system further has a second modulator device.

### CROSS-REFERENCE TO RELATED APPLICATIONS

This application is a continuation application of international patent application PCT/EP2024/059701, filed Apr. 10, 2024, designating the United States and claiming priority from German application 10 2023 111 486.7, filed May 3, 2023, and the entire content of both applications is incorporated herein by reference.

### TECHNICAL FIELD

The disclosure relates to a modulator system for a brake system of a trailer vehicle having a pneumatic brake installation. In particular, the modulator system is intended to be suitable for a trailer vehicle having at least two axles, the wheel speeds of which are sensed.

### BACKGROUND

Modern commercial vehicles have an electronic brake system in connection with a pneumatic brake installation. Individual components or assemblies can be configured in an integrated manner and link electronic/electrical functions to pneumatic functions. One assembly integrated in such a way is a modulator device which, in the simplest form, has a modulator and an electronic control unit or an electronic control device.

The modulator typically contains at least one pneumatic relay valve for outputting brake pressure and having inputs for control pressure and supply pressure, and two solenoid valves for modulating the control pressure. One of the two solenoid valves opens at least for control pressure, while the other solenoid valve can vent the brake pressure which has built up. Preferably, in the case of de-energized solenoid valves, only pneumatic control pressure reaches the control input of the relay valve. Further valves can be provided for controlling the solenoid valves; the valves can also be interconnected as a whole in different ways.

EP 0 829 406 A2 shows a modulator, referred to as a pressure modulator 28, having a relay valve and two solenoid valves. A solenoid valve as a switching device and an electronic control device are arranged upstream. The sum of these parts, namely the electronic control device, the switching device having the solenoid valve, the modulator having the relay valve and solenoid valves, can be referred to as a modulator device.

The electronic control device and the modulator are of particular importance for the modulator device. The function of the switching device and the switching logic of the solenoid valves can also be realized and/or substituted in another way. It is also possible for the switching device or a comparable component to be provided outside the modulator device, but in particular within the same. In practice, the modulator device is a component which is largely standardized by the manufacturer and which is produced and installed in large numbers, but can be configured and interconnected differently.

The electronic control device receives, inter alia, electrical signals which represent a brake request, and is provided with an input for wheel speed signals and an electrical output for connecting to the modulator. The electronic control device receives, inter alia, information from wheel speed sensors, via which it is also possible to ascertain a wheel which locks due to excessively high brake pressure. In this way, a control loop is formed with the components wheel speed sensor, modulator device and brake.

In practice, a plurality of such control loops can be present in an electronic brake system having a pneumatic brake installation. An electronic control device can also be assigned to a plurality of modulators. For instance, the system description retrieved from www.wabco.info/i/542 on Apr. 28, 2023 “TEBS E. VERSIONEN E0 BIS E6.5. Systembeschreibung” [TEBS E. VERSIONS E0 TO E6.5. System Description] (WABCO, edition 11, version 1 (11.2022), publication no.: 815 020 093 3) on page 32 under the designation “TEBS E Modulator” discloses a modulator device having control electronics, four input channels for wheel speed sensors and two modulators. In addition, the modulator device has further sensors, outputs, inputs, interfaces and valves.

A combination of an electronic control device and a valve arrangement for a modulator device is also shown in EP 2 190 706 B1. An input valve and an output valve are arranged upstream of a relay valve. In addition, a so-called backup valve is provided, which can provide the control input of the relay valve with a supply pressure.

If the electronic control device fails, the modulator or the modulators should continue to function as far as possible. At least the pneumatic functions should be maintained. The present solenoid valves are therefore switched and arranged such that, in the event of a power failure, the pneumatic control pressure is led through to the relay valve. The driver can continue to actuate the brake. Only the reaction time is prolonged. However, an electronically controlled braking process and anti-lock control are no longer possible.

### SUMMARY

In order to improve the fail safety of the brake system, in particular in connection with autonomous driving, the brake system should have increased redundancy.

In order to achieve the above, a modulator system according to the disclosure includes: The modulator system has a first modulator device which has a primary modulator and a first electronic control device. The primary modulator has an input for control pressure, an input for supply pressure, an output for brake pressure and an electrical input for electrical signals from the first electronic control device. The first electronic control device has an input for wheel speed signals and an output for connecting to the electrical input of the primary modulator. The primary modulator is able to be controlled by the first electronic control device. The modulator system furthermore has a second modulator device which has a secondary modulator and a second electronic control device. The secondary modulator has an input for supply pressure, an output for control pressure and an electrical input for electrical signals from the second electronic control device. The second electronic control device has an interface for receiving electrical signals from the first electronic control device, an input for wheel speed signals and an output for connecting to the electrical input of the secondary modulator. The secondary modulator is able to be controlled by the second electronic control device for outputting control pressure and the output for control pressure of the secondary modulator is connected to the input for control pressure of the primary modulator.

If the first electronic control device fails, the second modulator device provided according to the disclosure can partly take over the tasks thereof and thus allow important functions to be maintained. In the event of a fault, the primary modulator is not controlled electrically by the first electronic control device but rather pneumatically via its control pressure input which is connected to the output for control pressure of the secondary modulator. The latter can in particular optionally be controlled by the second electronic control device such that electronic control of the primary modulator is possible at least indirectly. The two modulator devices can be largely standardized and already known assemblies. The control output of the secondary modulator is conventionally an output for brake pressure and can provide a pneumatic control pressure for the primary modulator in the modulator system according to the disclosure. Venting can also take place via the secondary modulator. This achieves high redundancy for maintaining the basic functions of the brake system. Anti-lock control and stability control remain possible. In particular cases, restrictions exist depending on the configuration.

According to a further concept of the disclosure, the primary modulator can be able to be controlled by the first electronic control device for outputting brake pressure. The function of the first electronic control device goes beyond simple anti-lock control.

According to a further concept of the disclosure, the primary modulator can have an input for a pneumatic and/or electrical control pressure. Depending on the configuration, the primary modulator can receive information about the control pressure as pneumatic signals or electrical signals or in both ways.

According to a further concept of the disclosure, the secondary modulator can be able to be controlled by the second electronic control device for outputting control pressure. The function of the second electronic control device goes beyond simple anti-lock control.

According to a further concept of the disclosure, the secondary modulator can have an input for a pneumatic and/or electrical control pressure. Depending on the configuration, the secondary modulator can receive information about the control pressure as pneumatic signals or electrical signals or in both ways.

According to a further concept of the disclosure, the primary electronic control device and the secondary electronic control device can each have an electrical interface via which the primary electronic control device can transmit information about its status to the secondary electronic control device. This can also be a CAN-bus connection. Also, the connection does not have to be provided directly. A further control device can be interposed. It is important that an item of status information can be transmitted from the primary control device to the secondary control device. This allows intervention and/or activation of the second modulator device on very short notice.

According to a further concept of the disclosure, an electronic vehicle control device can be provided, having electrical interfaces for connecting to the first electronic control device and the second electronic control device and having an interface for receiving electrical signals which represent a brake request. In particular, this can be a vehicle control device which receives the brake request from the towing vehicle, in particular via a megabit Ethernet twisted pair interface (1000Base-T interface). In particular, the latter interface can be configured according to ISO 23870.

According to a further concept of the disclosure, the first electronic control device and second electronic control device can receive and process wheel speed signals from different axles. In a multi-axle trailer vehicle, in particular in a three-axle trailer vehicle, the second electronic control device only receives, for example, the signals from the front axle, while the first electronic control device only receives the signals from two other axles. Accordingly, when the second modulator device is active and the first electronic control device has failed, only the wheel speed signals from the first axle are processed for anti-lock control. Advantageously, the wheel speed sensors for both control devices can also be installed on a common axle. It is likewise possible for a wheel speed sensor to be connected to two control devices.

According to a further concept of the disclosure, the first electronic control device can be connected to a signal source other than the second electronic control device for receiving the electrical signals which represent a brake request. Signal source in this sense is an interface on the trailer vehicle, via which signals are received from the towing vehicle. Accordingly, the trailer vehicle can receive the brake request via two different interfaces.

According to a further concept of the disclosure, the first interface can be connected at least indirectly to an interface according to ISO 7638-2:2018 and the second interface can be connected at least indirectly to a 1000Base-T interface. Both interfaces are known in principle and allow rapid and reliable transfer of the required information. The 1000Base-T interface is a megabit Ethernet twisted pair interface as a data connection between the towing vehicle and the trailer vehicle. In particular, the 1000Base-T interface can be configured according to ISO 23870.

According to a further concept of the disclosure, the first interface can be connected at least indirectly to an interface according to SAE J560-2020. The latter interface is widespread at least in North America.

According to a further concept of the disclosure, the second interface can be connected at least indirectly to an interface according to SAE J560-2020 or a 1000Base-T interface. In particular, the 1000Base-T interface can be configured according to ISO 23870.

According to a further concept of the disclosure, the interfaces can be CAN-bus-compatible for receiving electrical signals.

According to a further concept of the disclosure, the first modulator device can have two primary modulators which are connected to the first electronic control device such that both primary modulators are able to be controlled by the first electronic control device for outputting brake pressure. In particular, a primary modulator can be provided on each side of the vehicle.

According to a further concept of the disclosure, the first modulator device can have a first combination of first electronic control device and primary modulator and a second combination of first electronic control device and primary modulator. Each combination controls the brakes on one side of the vehicle.

The disclosure also relates to a brake system for a trailer vehicle having a pneumatic brake installation, having a modulator system according to the disclosure.

The disclosure also relates to a trailer vehicle having a modulator system according to the disclosure or a brake system according to the disclosure.

Furthermore, the disclosure also relates to a method for operating a modulator system according to the disclosure or a brake system according to the disclosure. In this case, the method in particular has the following features: The second electronic control device receives status information from the first electronic control device and, in dependence on the received status information, the second electronic control device takes over the control of brake functions.

The method allows electronic control of the service brake of the trailer vehicle even if the first electronic control device fails. In addition, further functions of the brake can be maintained.

According to a further concept of the disclosure, provision can be made for the second electronic control device to control the secondary modulator for outputting control pressure in dependence on the received status information. The second electronic control device controls the outgoing control pressure and, in particular, cannot be restricted to simple anti-lock control.

According to a further concept of the disclosure, absent status information can also be evaluated as status information, wherein, after a defined period of time has elapsed without status information being input, the second electronic control device takes over the control of brake functions. The first electronic control device cyclically sends status information to the second electronic control device. The second electronic control device checks whether an item of status information has been received within a cycle time or a somewhat longer defined period of time. If not, the second electronic control device takes over the control of brake functions.

According to a further concept of the disclosure, after a defined period of time has elapsed without status information being input, the second electronic control device can control the secondary modulator for outputting control pressure. Beyond anti-lock control, the secondary modulator can output control pressure for targeted braking.

According to a further concept of the disclosure, the second electronic control device can control the secondary modulator for carrying out brake functions once the second electronic control device has received an item of status information “fault” from the first electronic control device. This can be the general information that there is a fault at all. Alternatively or in addition, the status information can contain more precise details about the fault. The second electronic control device can then carry out corresponding measures and, in particular, optionally control the secondary modulator for outputting control pressure.

According to a further concept of the disclosure, the second electronic control device can control the secondary modulator for outputting modulated control pressure in order to carry out anti-lock control or stability control. If the first electronic control device fails, it can no longer carry out anti-lock control or stability control. These functions are then taken over by the second electronic control device. In particular, the second electronic control device can carry out single-channel control. The convenience is somewhat lower than in the case of two-channel control but the outlay in terms of apparatus is likewise reduced.

According to a further concept of the disclosure, the second electronic control device can only receive information about wheel speeds from wheel speed sensors of one axle. That is, that only the wheel speeds of one axle are sensed for the control by the second electronic control device. Further axles can have wheel speed sensors which can in particular optionally be connected only to the first electronic control device.

The disclosure also relates to a method for operating a modulator system according to the disclosure or a brake system according to the disclosure in a trailer vehicle having an electronic vehicle control device. In this case, the method in particular has the following features: The electronic vehicle control device receives status information from the first electronic control device and/or from the second electronic control device and, in dependence on the received status information, the electronic vehicle control device prioritizes the first electronic control device or the second electronic control device for controlling brake functions.

As a superordinate entity, the vehicle control device controls which of the two electronic control devices are to control the brake functions of the trailer vehicle, depending on status information received. For example, the vehicle control device activates the second electronic control device if no status information has been received from the first electronic control device over a defined period of time. The activation can take place in particular via the same connection via which the status information is received or expected.

### BRIEF DESCRIPTION OF DRAWINGS

The invention will now be described with reference to the drawings wherein:

FIG. 1 shows a trailer vehicle having a first embodiment of a brake system;

FIG. 2 shows a trailer vehicle having a second embodiment of the brake system;

FIG. 3 shows a trailer vehicle having a third embodiment of the brake system;

FIG. 4 shows a trailer vehicle having a fourth embodiment of the brake system, in particular for North America;

FIG. 5 shows a trailer vehicle having a fifth embodiment of the brake system, in particular for North America;

FIG. 6 shows a trailer vehicle having a sixth embodiment of the brake system, in particular for North America;

FIG. 7 shows a modulator as prior art; and,

FIG. 8 shows a modulator device as prior art.

### DETAILED DESCRIPTION

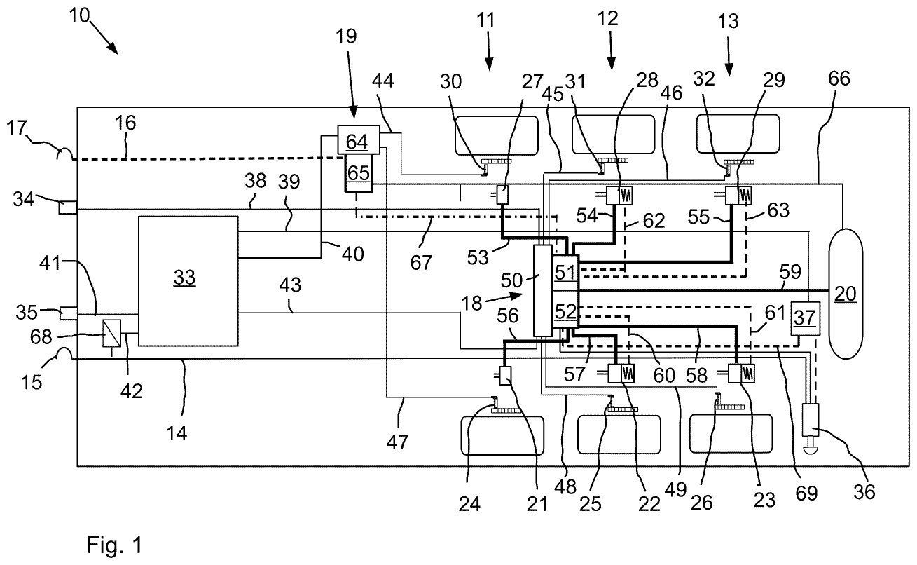

A first embodiment of a trailer vehicle 10 having three axles 11, 12, 13 and a brake system according to the disclosure is shown in FIG. 1. Components of the brake system having a pneumatic brake installation are, inter alia, a supply pressure line 14 having a coupling head 15 “red”, a control pressure line 16 having a coupling head 17 “yellow” (usually “blue” in North America), a first modulator device 18, a second modulator device 19, a compressed-air supply 20, left-side wheel brake cylinders 21, 22, 23, left-side wheel speed sensors 24, 25, 26, right-side wheel brake cylinders 27, 28, 29, right-side wheel speed sensors 30, 31, 32, an electronic vehicle control device 33, an electrical interface 34 to the towing vehicle (not shown) and a further electrical interface 35 to the towing vehicle. In addition, a park release valve 36 and an electronic parking brake 37 are provided in this embodiment.

Together with the lines provided for connection, the two modulator devices 18, 19 form a modulator system which is not referred to in any greater detail. Lines 38 to 49 are electrical lines. These also include power supplies, signal lines and data lines and combinations thereof. The electrical lines 38 to 49 can also be interfaces connected to the devices 18, 19, 33 for transmitting information. All other lines visible in FIG. 1 are pneumatic lines.

The first modulator device 18 here has a first electronic control device 50 and two primary modulators 51, 52. The right-side primary modulator 51 supplies the wheel brake cylinders 27, 28, 29 with brake pressure via pneumatic lines 53, 54, 55. Analogously, the left-side primary modulator 52 supplies the wheel brake cylinders 21, 22, 23 with brake pressure via pneumatic lines 56, 57, 58. The two primary modulators 51, 52 receive supply pressure from the compressed-air supply 20 via a pneumatic line 59.

The wheel brake cylinders 22, 23, 28, 29 are configured as combination brake cylinders having spring accumulators not specifically numbered, which receive supply pressure from the primary modulators 51, 52 via pneumatic lines 60, 61, 62, 63.

The construction and mode of operation of the first modulator device 18 is known in principle and is used in practice; see the above-mentioned system description “TEBS E”, pages 25 and 27, ABS configuration 4S/2M. The modulator device therein is referred to as a “TEBS E modulator”.

The second modulator device 19 has a second electronic control device 64 and a secondary modulator 65. The indications “second” and “secondary” are used in this context only to indicate the association with the second modulator device 19. The second modulator device 19 can be a modified or simplified variant of the first modulator device 18.

The secondary modulator 65 is connected to the coupling head 17 “yellow” via the control pressure line 16 and receives pneumatic control pressure via the latter. Via a pneumatic line 66, there is a connection to the compressed-air supply 20 for supplying with supply pressure. Finally, there is a connection via a pneumatic line 67 to the primary modulators 51, 52, namely for transmitting control pressure. That is, the pressure that is output from the secondary modulator 65 is control pressure for the primary modulators 51, 52.

The wheel speed sensors 24, 30 of the axle 11 are connected to the second electronic control device 64 such that at least one single-channel ABS control is possible for the axle 11.

The second electronic control device 64 is connected to the electronic vehicle control device 33 via the electrical line 40. At the same time, the electronic vehicle control device 33 is connected to the first electronic control device 50 via the electrical line 43. The lines 40, 43 can in particular at the same time be interfaces for transmitting data between the control devices 33, 50 and 64.

The electronic vehicle control device 33 is connected to the interface 35 via the electrical line 41. The electrical lines 40, 41, 43 can in particular be CAN-bus-compatible, in particular also the line 38. As a result, the two electronic control devices 50, 64 can be controlled by the towing vehicle (not shown) via interfaces 34, 35 which are separate from one another. At the same time, an exchange of information from the first electronic control device 50 to the second electronic control device 64 is possible indirectly via the vehicle control device 33.

The vehicle control device 33 receives an electrical pressure signal relating to the supply pressure via a pressure transducer 68.

Here, the electrical interface 34 to the towing vehicle can in particular be an interface according to ISO 7638-2:2018. Here, the interface 35 can in particular be a 1000Base-T interface, in particular according to ISO 23870.

If the first electronic control device 50 fails or a fault of same is communicated to the second control device 64, the latter becomes active and can transfer pneumatic control pressure to the primary modulators 51, 52 via the line 67, which primary modulators supply all the wheel brake cylinders 21 to 23 and 27 to 29 with brake pressure. A corresponding brake request is transmitted to the second electronic control device 64 via the interface 35 and the vehicle control device 33.

The electronic parking brake 37 is connected to the primary modulators 51, 52 via a pneumatic line 69 and, therewith, supplies spring accumulator pressure or vents the spring accumulators.

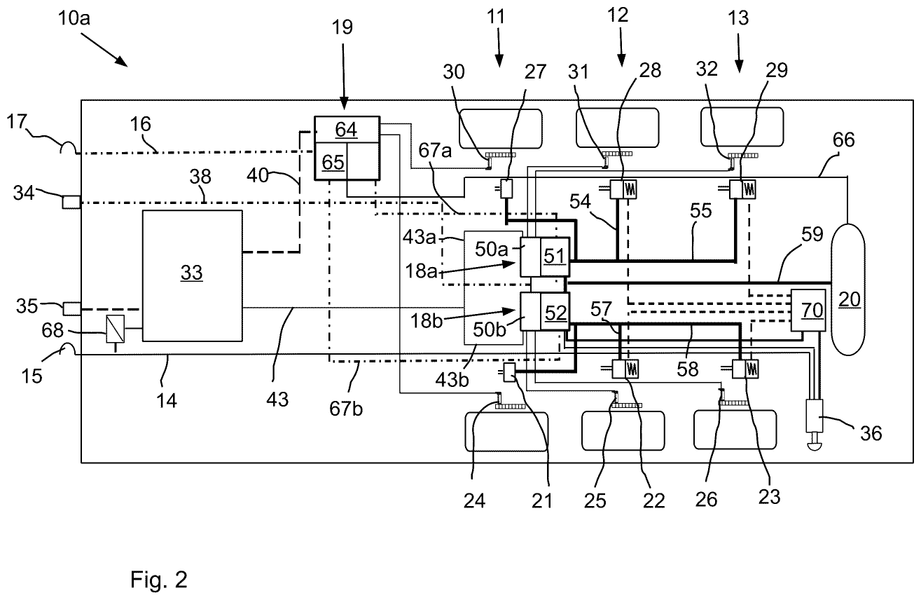

FIG. 2 shows a trailer vehicle 10a, the brake system of which largely corresponds to the illustration in FIG. 1. Where appropriate, the same reference signs are indicated. Differing reference signs indicate special features.

Instead of only one first modulator device 18, two first modulator devices 18a, 18b are provided here. Both receive an electrical brake request from the vehicle control device 33 via the lines 43, 43a, 43b. Via this and via the line 40, there is also a data connection to the second electronic control device 64.

The two primary modulators 51, 52 receive control pressure from the secondary modulator 65 via lines 67a, 67b.

Each of the two first modulator devices 18a, 18b forms a 2S/1M configuration for ABS control such that each modulator device 18a, 18b controls the wheel brake cylinders 22, 23, 28, 29 on its own side of the vehicle. In the event of a fault, the second modulator device 19 takes over with the secondary modulator 65 in the 2S/1M configuration and accordingly single-channel ABS control.

Of the two first modulator devices 18a, 18b, one takes over a master function and the other takes over a slave function. In the normal case, therefore, both primary modulators 51, 52 output identical brake pressures despite the individual control devices 50a, 50b. Only as a general rule—as already mentioned above—each modulator device 18a, 18b takes over the control for its own side of the vehicle.

An overload protection means 70, which is provided here instead of the electronic parking brake 37 shown in FIG. 1, is connected to the primary modulators 51, 52 via the pneumatic line 69. The spring accumulators of the wheel brake cylinders 22, 23, 28, 29, which are not referred to in any greater detail, are supplied with spring accumulator pressure from the overload protection means 70, see pneumatic lines 60a, 61a, 62a, 63a.

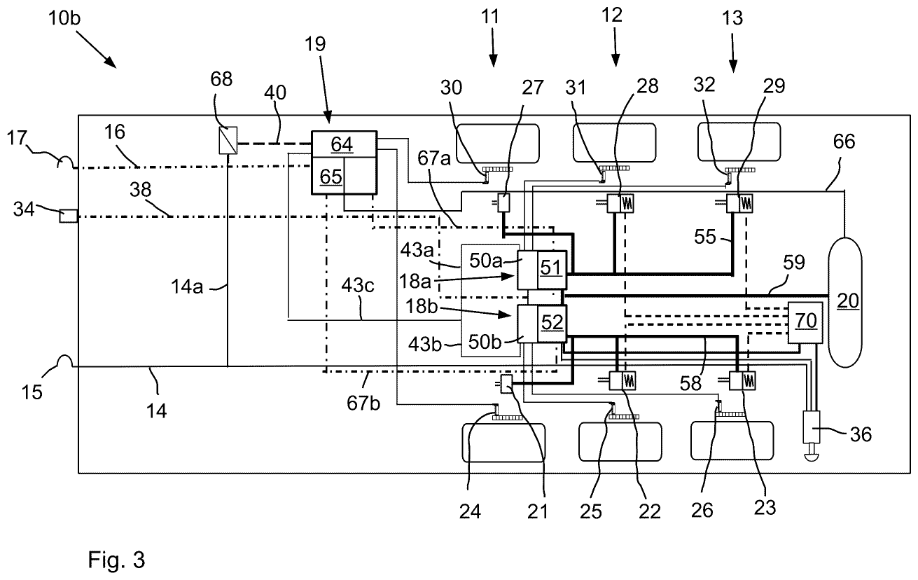

FIG. 3 shows a trailer vehicle 10b having a brake system as in FIG. 2, but without the vehicle control device 33 with interface 35. The pressure transducer 68 is connected directly to the second electronic control device 64 via the electrical line 40 and detects the pressure in the supply pressure line 14 with a branch 14a.

The second electronic control device 46 is connected to the two first electronic control devices 50a, 50b via an electrical line 43c to the lines 43a, 43b. This allows a data exchange between the control devices 64, 50a, 50b, at least a status transmission to the control device 64.

At the same time, the control device 64 receives, via the control devices 50a, 50b, the electrical brake request applied to the interface 34 and possibly further information, depending on the configuration of the interface 34. For this purpose, the line 38 can additionally be looped through one of the control devices 50a, 50b.

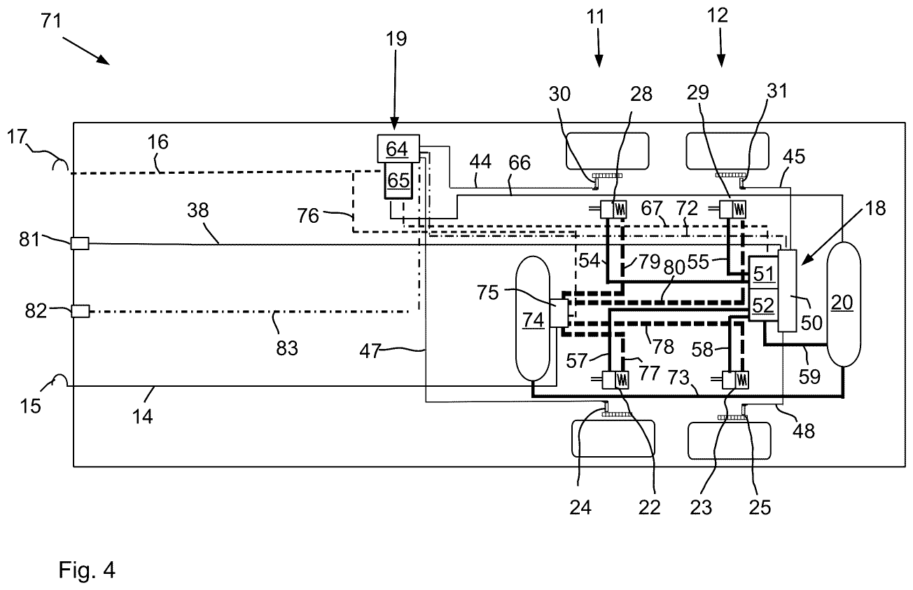

FIG. 4 shows a trailer vehicle 71 having two axles 11, 12 and a brake system according to the disclosure. Insofar as there is agreement with preceding embodiments, the same reference signs are indicated. Deviating therefrom, the interface 34 to the towing vehicle here can be in particular an interface according to SAE J560_202002, which supplies the first electronic control device 50 with electrical voltage.

The wheel brake cylinders 22, 23, 28, 29 configured as combination brake cylinders are assigned to both axles 11, 12. Only the wheel speed sensors 25, 31 of the axle 12 are connected to the first electronic control device 50. The wheel speed sensors 24, 30 of the axle 11 are connected to the second electronic control device 64.

Between the control devices 50, 64 there is an electrical connection 72 which can be used in particular for transmitting status to the control device 64 and in particular also for exchanging data.

A second compressed-air supply 74, which is supplied by the supply pressure line 14 via a valve arrangement 75, is connected to the compressed-air supply 20 via a pneumatic line 73. The valve arrangement can in particular contain an overload protection means and is connected to the control pressure line 16 via a pneumatic line 76. Moreover, the spring accumulators, which are not referred to in any greater detail, can be filled with supply pressure via the valve arrangement 75, see pneumatic lines 77, 78, 79, 80.

Two electrical interfaces 81, 82 are provided for connecting to the towing vehicle (not shown). The interface 81 can in particular be an interface according to SAE J560-2020, likewise the interface 82. However, the interface 82 can also be a 1000Base-T interface. The interface 81 is connected to the first electronic control device 50 via the electrical line 38, while the interface 82 is connected to the second electronic control device 64 via an electrical line 83. Thus, the control devices 50, 64 can receive an electrical brake request from different sources, if desired. If the control device 50 fails or a fault occurs, the control device 64 of the second modulator device 19 takes over the control over the brake system. As a result, the secondary modulator 65 can output control pressure to the primary modulators 51, 52 via the pneumatic line 67.

The second modulator device 19 is, just as in the preceding embodiments, inserted into the pneumatic lines 16, 67 between the coupling head 17 and the primary modulators 51, 52. At the same time, the second modulator device 19 is supplied with voltage from a source other than the first modulator device 18 via the interface 82.

The communication between the control devices 50, 64 via the electrical line 72 can take place in the manner of a so-called power line communication (PLC) or via a CAN bus. If the control device 50 fails, anti-lock control via the second modulator device 19 is still possible. This can modulate the control pressure in the pneumatic line 67 and thus control the pressure in the wheel brake cylinders 22, 23, 28, 29 and prevent locking. In this embodiment, a 2S/2M configuration is present for the first modulator device 18 because only the two wheel speed sensors 25, 31 are connected to the control device 50 and two modulators 51, 52 are operative.

A 2S/1M configuration results for the second modulator device 19.

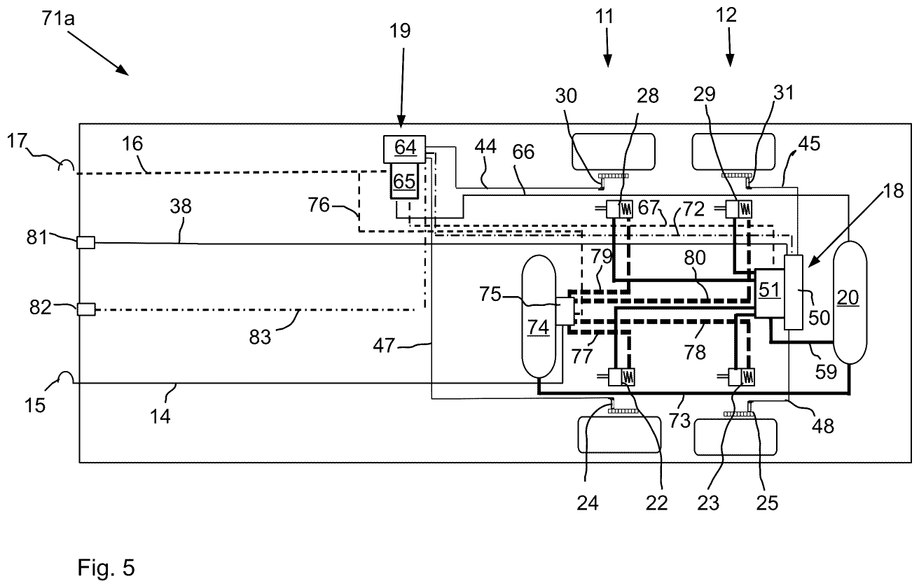

The embodiment in FIG. 5 differs from the embodiment in FIG. 4 only with respect to the configuration of the first modulator device 18. According to FIG. 5, the first modulator device has only one primary modulator 51. This results in a 2S/1M configuration for the first modulator device 18, just as for the second modulator device 19. Therefore, both sides of the vehicle always receive the same brake pressure even during fault-free operation.

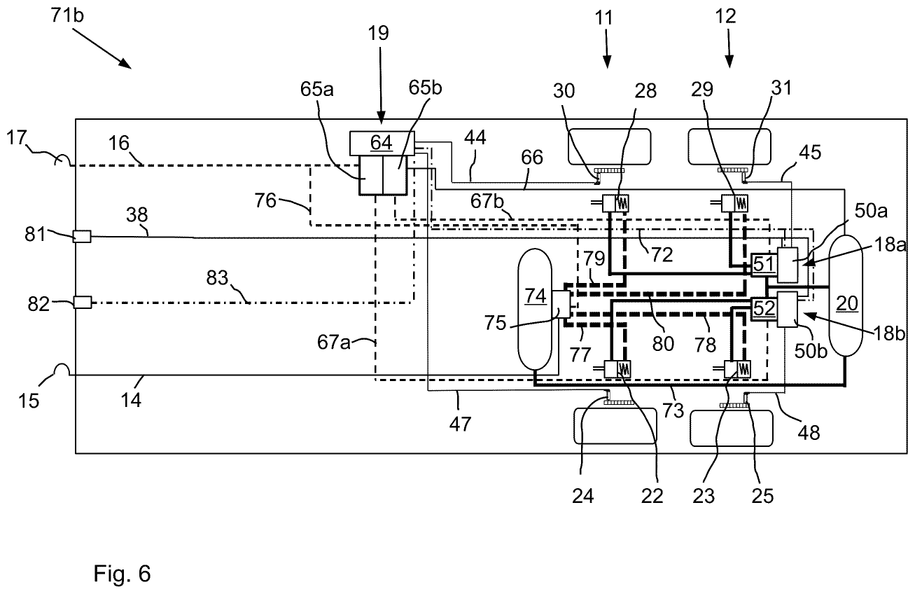

A further modification to FIG. 4 is shown in FIG. 6. Here, two first modulator devices 18a, 18b are provided, as already shown in FIG. 2. Moreover, the second modulator device 19 has two secondary modulators 65a, 65b. Accordingly, a two-times 1S/1M configuration is present during fault-free operation, and a 2S/2M configuration is present in the event of a fault by the second modulator device 19. That is, that the two sides of the vehicle can be controlled differently even in the event of a fault.

Common to all the embodiments is the interconnection of the second modulator device 19 into the control line 16 leading to the first modulator device 18 or 18a, 18b. Moreover, in all cases, there is an electrical connection between the control devices 50 or 50a, 50b and 64. Finally, the second control device 64 receives data from two wheel speed sensors on different sides of the vehicle and is connected via its own electrical interface to the towing vehicle, at least indirectly, except in FIG. 3.

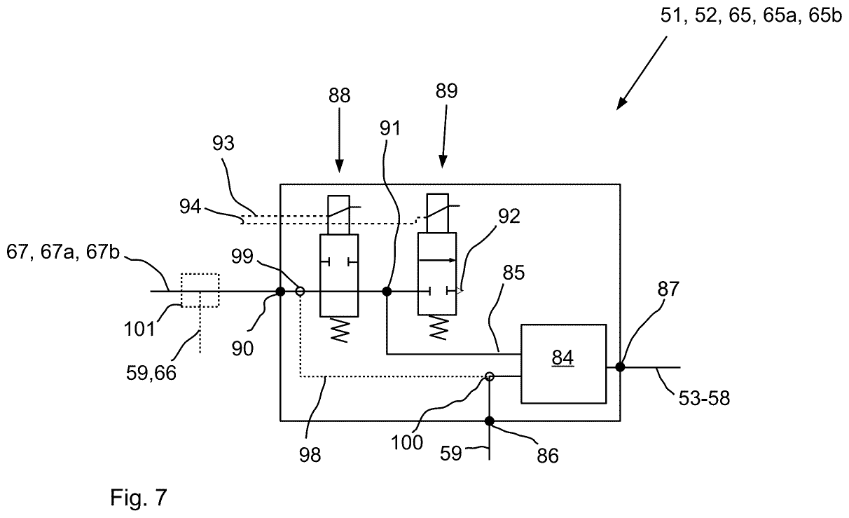

The modulators 51, 52, 65, 65a, 65b are typically configured as in the prior art according to EP 0 829 406 A2 and as illustrated in FIG. 7, optionally with additional components or in extended form. A relay valve 84 having an input 85 for control pressure and an input 86 for supply pressure and an output 87 for brake pressure can be seen. To the output 87 are connected, for example, on the secondary modulator 65 the line 67 or on the primary modulator 51 the lines 53-55.

Two solenoid valves 88, 89 are arranged upstream of the input 85 for control pressure. As illustrated, the solenoid valve 88 is continuously de-energized such that control pressure can pass from an input 90 to a connection point 91 and from there to the input 85. The solenoid valve 89 is arranged downstream of the connection point 91 and blocks in the de-energized state. When energized, a connection from the input 85 to a vent 92 is able to be established via the solenoid valve 89. The two solenoid valves 88, 89 are able to be controlled separately via electrical inputs 93, 94.

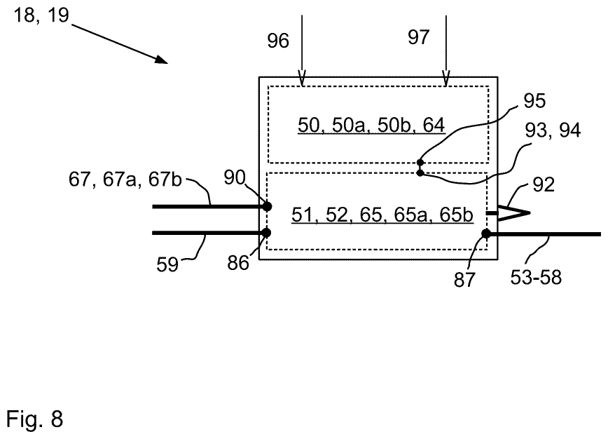

FIG. 8 shows preferred inputs and outputs of the modulator devices 18, 19. The latter are individually prior art, but not in combination with one another. Electrical inputs/outputs are illustrated by thin arrows and pneumatic inputs/outputs are illustrated by thicker arrows. Where appropriate, reference signs of FIGS. 1 to 7 are also indicated. The configuration of the modulator devices 18, 19 can correspond to the configuration in the above-mentioned system description “TEBS E”or can be modified with respect to this.

Shown are the electrical inputs 93, 94 to the modulator 51, 52, 65, 65a, 65b, an electrical output 95 to the control device 50, 50a, 50b, 64, an optionally multi-channel input 96 for signals of the wheel speed sensors, and an electrical input/output 97 for connecting to the respectively other modulator device 18, 19 or to a line 38, 40 for transmitting data and/or voltage. Moreover, the already mentioned pneumatic inputs/outputs 86, 87, 90, 92 are illustrated.

FIG. 7 illustrates two further optional embodiments, the first of which is not prior art.

In the first optional embodiment, a point 99 on the input side of the solenoid valve 88 and a point 100 between the input 86 and the relay valve 84 can be connected to one another via an internal connection 98. In this case, the input 90 can be dispensed with. In this configuration, the solenoid valves 88, 89 control the supply pressure for generating control pressure for the relay valve 84.

In the second optional embodiment, a switching valve 101 can be arranged upstream of the output 90, which switching valve is able to be used to selectively supply control pressure or supply pressure to the input 90, analogously to the switching valve device 4 in FIG. 2 of EP 0 829 406 A2.

For a control device 50, 64 having two modulators 51, 52, 65a, 65b, as illustrated in FIGS. 1, 4, 5, 6 and in the system description “TEBS E”, the control devices 50, 64 can accordingly have more outputs. The two modulators 51, 52 or 65a, 65b can also have connections to one another, but these connections have no importance in conjunction with the essence of the disclosure. Finally, the modulators can have a multi-channel configuration, that is, control a plurality of wheel brake cylinders 21-23, 27-29 via a plurality of outputs. For the sake of simplicity, only one output 87 is illustrated.

Which lines can be connected to which inputs and outputs in particular are listed below.

Inputs 96 for wheel speed signals: Lines 44-49. Wheel speed signals are supplied via the lines 44, 47 or 45, 46, 48, 49.

Input/output 97 for connecting to interface or control device: Lines 38, 40, 43, 43a, 43b, 43c, 72, 83. An electrical control pressure signal as a brake request is supplied via the lines 38, 40, 43, 43a, 43b, 43c, 72, 83. Alternatively or in addition, data, for example status information, can be transmitted or exchanged via these lines.

Pneumatic input 90 for control pressure: Lines 16, 67. A pneumatic control pressure signal can be supplied via the lines 16, 67.

Pneumatic input 86 for supply pressure: Lines 59, 66, 69. The supply with supply pressure can take place via the pneumatic lines 59, 66, 69.

Pneumatic outputs 92 for the venting: Lines are not illustrated.

Pneumatic outputs 87 for control or brake pressure: Lines 53-58, 67, 67a, 67b. Brake pressure is output via the output 87 and subsequent lines 53-58. This applies to the modulators 51, 52. In the embodiments shown, the modulators 65, 65a, 65b output control pressure via the output 87 and the lines 67, 67a, 67b.

It is understood that the foregoing description is that of the preferred embodiments of the invention and that various changes and modifications may be made thereto without departing from the spirit and scope of the invention as defined in the appended claims.

### LIST OF REFERENCE SIGNS AS PART OF THE DESCRIPTION

10 trailer vehicle
10a trailer vehicle
10b trailer vehicle
11 axle (front)
12 axle (middle)
13 axle (rear)
14 supply pressure line
14a branch
15 coupling head supply pressure “red”
16 control pressure line
17 coupling head control pressure “yellow”
18 first modulator device
18a first modulator device
18b first modulator device
19 second modulator device
20 compressed-air supply
21 left-side wheel brake cylinder
22 left-side wheel brake cylinder
23 left-side wheel brake cylinder
24 left-side wheel speed sensor
25 left-side wheel speed sensor
26 left-side wheel speed sensor
27 right-side wheel brake cylinder
28 right-side wheel brake cylinder
29 right-side wheel brake cylinder
30 right-side wheel speed sensor
31 right-side wheel speed sensor
32 right-side wheel speed sensor
33 electronic vehicle control device
34 electrical interface to the towing vehicle
35 electrical interface to the towing vehicle
36 park release valve
37 electronic parking brake
38 electrical line
39 electrical line
40 electrical line
41 electrical line
42 electrical line
43 electrical line
43a electrical line
43b electrical line
43c electrical line
44 electrical line
45 electrical line
46 electrical line
47 electrical line
48 electrical line
49 electrical line
50 first electronic control device
50a first electronic control device
50b first electronic control device
51 primary modulator
52 primary modulator
53 pneumatic line (brake pressure)
54 pneumatic line (brake pressure)
55 pneumatic line (brake pressure)
56 pneumatic line (brake pressure)
57 pneumatic line (brake pressure)
58 pneumatic line (brake pressure)
59 pneumatic line (supply pressure)
60 pneumatic line (spring accumulator pressure)
60a pneumatic line (spring accumulator pressure)
61 pneumatic line (spring accumulator pressure)
61a pneumatic line (spring accumulator pressure)
62 pneumatic line (spring accumulator pressure)
62a pneumatic line (spring accumulator pressure)
63 pneumatic line (spring accumulator pressure)
63a pneumatic line (spring accumulator pressure)
64 second electronic control device
65 secondary modulator
65a secondary modulator
65b secondary modulator
66 pneumatic line (supply pressure)
67 pneumatic line (control pressure)
67a pneumatic line (control pressure)
67b pneumatic line (control pressure)
68 pressure transducer
69 pneumatic line (spring accumulator pressure)
70 overload protection means
71 trailer vehicle
71a trailer vehicle
71b trailer vehicle
72 electrical connection
73 pneumatic line (supply pressure)
74 second compressed-air supply
75 valve arrangement
76 pneumatic line (control pressure)
77 pneumatic line (spring accumulator pressure)
78 pneumatic line (spring accumulator pressure)
79 pneumatic line (spring accumulator pressure)
80 pneumatic line (spring accumulator pressure)
81 electrical interface to the towing vehicle
82 electrical interface to the towing vehicle
83 electrical line
84 relay valve
85 pneumatic input (control pressure)
86 pneumatic input (supply pressure)
87 pneumatic output (brake pressure)
88 solenoid valve
89 solenoid valve
90 pneumatic input (control pressure)
91 connection point (control pressure)
92 vent
93 electrical input
94 electrical input
95 electrical output
96 electrical input for wheel speeds
97 electrical input/output
98 connection
99 point
100 point
101 switching valve

1. A modulator system for a brake system of a trailer vehicle, the modulator system comprising:
a pneumatic brake installation having a first modulator device including a primary modulator and a first electronic control device;
said primary modulator having a control pressure input for control pressure, a primary supply pressure input for supply pressure, a primary brake pressure outlet, and a primary electrical input for electrical signals from said first electronic control device;
said first electronic control device having an input for wheel speed signals and an output for connecting to said primary electrical input of said primary modulator;
said primary modulator being configured to be controlled by said first electronic control device;
said pneumatic brake installation having a second modulator device including a secondary modulator and a second electronic control device;
said secondary modulator having a secondary supply pressure input for supply pressure, a secondary control pressure output for control pressure, and a secondary electrical input for electrical signals from said second electronic control device;
said second electronic control device having an interface for receiving the electrical signals from said first electronic control device, a second wheel speed signal input for wheel speed signals and a second output for connecting to said secondary electrical input of said secondary modulator;
said secondary modulator being configured to be controlled by said second electronic control device for outputting control pressure; and,
said secondary control pressure output for control pressure of said secondary modulator being connected to said control pressure input for control pressure of said primary modulator.

2. The modulator system of claim 1, wherein said primary modulator is configured to be controlled by said first electronic control device for outputting brake pressure.

3. The modulator system of claim 1, wherein said primary modulator has an input for at least one of a pneumatic control pressure and an electrical control pressure.

4. The modulator system of claim 1, wherein said secondary modulator is configured to be controlled by said second electronic control device for outputting control pressure.

5. The modulator system of claim 1, wherein said secondary modulator has an input for at least one of a pneumatic control pressure and an electrical control pressure.

6. The modulator system of claim 1, wherein said first electronic control device and said second electronic control device each have an electrical interface via which said first electronic control device is configured to transmit information about a status of said first electronic control device to said second electronic control device.

7. The modulator system of claim 1 further comprising an electronic vehicle control device having electrical interfaces for connecting to said first electronic control device and said second electronic control device and having an interface for receiving electrical signals which represent a brake request.

8. The modulator system of claim 1, wherein said first electronic control device and said second electronic control device receive and process the wheel speed signals from different axles.

9. The modulator system of claim 1, wherein said first electronic control device is connected to a signal source other than said second electronic control device for receiving electrical signals which represent a brake request.

10. The modulator system of claim 1, wherein said first electronic control device has a first electronic control device interface which is connected at least indirectly to an ISO interface according to ISO 7638-2:2018 and said interface of said second electronic control device is connected at least indirectly to a 1000Base-T interface.

11. The modulator system of claim 1, wherein said first electronic control device has a first electronic control device interface which is connected at least indirectly to an SAE interface according to SAE J560-2020.

12. The modulator system of claim 1, wherein said interface of said second electronic control device is connected at least indirectly to a SAE interface according to SAE J560-2020 or a 1000Base-T interface.

13. The modulator system of claim 1, wherein said interface is CAN-bus-compatible for receiving the electrical signals.

14. The modulator system of claim 1, wherein said first modulator device has two primary modulators which are connected to said first electronic control device such that said two primary modulators are able to be controlled by said first electronic control device for outputting brake pressure.

15. The modulator system of claim 1, wherein said first modulator device has a first combination of said first electronic control device and said primary modulator and a second combination of said first electronic control device and said primary modulator.

16. A brake system for a trailer vehicle comprising the pneumatic brake installation of claim 1.

17. A trailer vehicle comprising the modulator system of claim 1.

18. A trailer vehicle comprising the brake system of claim 16.

19. A method for operating a modulator system for a brake system of a trailer vehicle, the modulator system including a pneumatic brake installation having a first modulator device including a primary modulator and a first electronic control device; the primary modulator having a control pressure input for control pressure, a primary supply pressure input for supply pressure, a primary brake pressure outlet, and a primary electrical input for electrical signals from the first electronic control device; the first electronic control device having an input for wheel speed signals and an output for connecting to said primary electrical input of the primary modulator; the primary modulator being configured to be controlled by the first electronic control device; the pneumatic brake installation having a second modulator device including a secondary modulator and a second electronic control device; the secondary modulator having a secondary supply pressure input for supply pressure, a secondary control pressure output for control pressure, and a secondary electrical input for electrical signals from the second electronic control device; the second electronic control device having an interface for receiving the electrical signals from the first electronic control device, a second wheel speed signal input for wheel speed signals and a second output for connecting to the secondary electrical input of the secondary modulator; the secondary modulator being configured to be controlled by the second electronic control device for outputting control pressure; and, the secondary control pressure output for control pressure of the secondary modulator being connected to the control pressure input for control pressure of the primary modulator, the method comprising:
receiving at the second electronic control device status information from the first electronic control device; and,
in dependence on the received status information, the second electronic control device taking over the control of brake functions.

20. The method of claim 19, wherein the second electronic control device controls the secondary modulator for outputting control pressure in dependence on the received status information.

21. The method of claim 19, wherein absent status information is also evaluated as status information; and, after a defined period of time has elapsed without the status information being input, the second electronic control device takes over the control of the brake functions.

22. The method of claim 20, wherein, after a defined period of time has elapsed without the status information being input, the second electronic control device controls the secondary modulator for outputting control pressure.

23. The method of claim 19, wherein the second electronic control device controls the secondary modulator for carrying out the brake functions once the second electronic control device has received an item of the status information “fault” from the first electronic control device.

24. The method of claim 19, wherein the second electronic control device controls the secondary modulator for outputting modulated control pressure in order to carry out anti-lock control or stability control.

25. The method of claim 19, wherein the second electronic control device only receives information about wheel speeds from wheel speed sensors of one axle.

26. A method for operating a modulator system for a brake system of a trailer vehicle, the modulator system including a pneumatic brake installation having a first modulator device including a primary modulator and a first electronic control device; the primary modulator having a control pressure input for control pressure, a primary supply pressure input for supply pressure, a primary brake pressure outlet, and a primary electrical input for electrical signals from the first electronic control device; the first electronic control device having an input for wheel speed signals and an output for connecting to said primary electrical input of the primary modulator; the primary modulator being configured to be controlled by the first electronic control device; the pneumatic brake installation having a second modulator device including a secondary modulator and a second electronic control device; the secondary modulator having a secondary supply pressure input for supply pressure, a secondary control pressure output for control pressure, and a secondary electrical input for electrical signals from the second electronic control device; the second electronic control device having an interface for receiving the electrical signals from the first electronic control device, a second wheel speed signal input for wheel speed signals and a second output for connecting to the secondary electrical input of the secondary modulator; the secondary modulator being configured to be controlled by the second electronic control device for outputting control pressure; and, the secondary control pressure output for control pressure of the secondary modulator being connected to the control pressure input for control pressure of the primary modulator, the method comprising:
receiving at the electronic vehicle control device status information from at least one of the first electronic control device and the second electronic control device; and,
in dependence on the received status information, prioritizing via the electronic vehicle control device the first electronic control device or the second electronic control device for controlling the brake functions.
